(19) United States
(12) Patent Application Publication
(10) Pub. No.: US 2026/0238412 A1
(43) Pub. Date: Aug. 13, 2026

(54) TECHNIQUES FOR SUPPORTING SUB-BAND FULL-DUPLEX WIRELESS COMMUNICATIONS

(71) Applicant: Apple Inc., Cupertino, CA (US)

(72) Inventors: Seyed Ali Akbar FAKOORIAN, San Diego, CA (US); Wei ZENG, Saratoga, CA (US); Dawei ZHANG, Saratoga, CA (US)

(21) Appl. No.: 19/156,553

(22) PCT Filed: Feb. 14, 2024
(86) PCT No.: PCT/US2024/015744

§ 371 Date: Aug. 14, 2025

Related U.S. Application Data
(60) Provisional application No. 63/484,889, filed on Feb. 14, 2023.

(51) Int. Cl. H04L 5/00; H04W 72/115

(52) U.S. Cl. CPC H04L 5/0044; H04W 72/115

(57) ABSTRACT

Techniques for supporting SBFD wireless communications between full-duplex base stations and half-duplex UEs with SFBD awareness are disclosed. Some embodiments are directed to collision handling, such as when a half-duplex UE is scheduled to receive and transmit simultaneously on DL and UL sub-bands. In some such embodiments, UL grants, DL grants, and dynamic grants may be assigned different priority levels and cancellation timelines may be utilized to prioritize different grant types (e.g., by causing scheduled communications corresponding to grants with lower priority to be dropped). Many embodiments are directed to switching to non-SBFD operation, such as within a SBFD slot allocation. In many such embodiments, SBFD aware UEs may receive indications to switch to non-SBFD operation, such as for a number of slots and/or period of time.

### CROSS-REFERENCE TO RELATED APPLICATIONS

This application claims the benefit of and priority to U.S. Provisional Patent Application No. 63/484,889 filed Feb. 14, 2023. The entirety of which is incorporated herein by reference.

### FIELD OF INVENTION

This disclosure related generally to wireless technology and more particularly to supporting sub-band full-duplex (SFBD) wireless communications for mobile user equipment.

### BACKGROUND

In telecommunications, 5G is the fifth-generation technology standard for broadband cellular networks. Like its predecessors, 5G networks are cellular networks, in which the service area is divided into small geographical areas called network cells (or cells). The 3rd Generation Partnership Project (3GPP) is the industry consortium that sets standards for 5G. In 5G, a number of different features are supported, such as full-duplex base stations. A duplex communication system is a point-to-point system composed of two or more connected parties or devices that can communicate with one another in both directions. Duplex systems are typically employed by cellular networks, either to allow for simultaneous communication in both directions between two connected parties or to provide a reverse path for the monitoring and remote adjustment of equipment in the field. Generally, there are two types of duplex communication systems: full-duplex and half-duplex. In a full-duplex system, both parties can communicate with each other simultaneously. In a half-duplex system, both parties can communicate with each other, but not simultaneously.

On the other hand, full-duplex emulation may refer to dividing forward and reverse communication channels on the same physical communication medium in networks in which channel access methods are used in point-to-multipoint networks, such as 5G cellular networks. Types of full-duplex emulation may include time-division duplexing (TDD) and frequency-division duplexing (FDD). TDD may refer to the application of time-division multiplexing to separate outward and return signals. TDD emulates full-duplex communication over a half-duplex communication link. FDD may refer to transmitters and receivers that operate using different carrier frequencies. In FDD, uplink (UL) and downlink (DL) sub-based are separated by a frequency offset, or guard band.

### BRIEF SUMMARY

Processes, machines, and articles of manufacture for supporting SBFD wireless communications are described. It will be appreciated that the embodiments may be combined in any number of ways without departing from the scope of this disclosure.

Embodiments may include determining a sub-band full-duplex (SBFD) slot is scheduled for a UE to simultaneously receive based on a downlink (DL) grant and transmit based on an uplink (UL) grant; identifying the DL grant or the UL grant as a primary grant, wherein the DL grant or the UL grant not identified as the primary grant comprises a secondary grant; and utilizing a cancellation timeline to prioritize the primary grant over the secondary grant.

Embodiments may include communicating with a base station based on sub-band full-duplex (SBFD) operations using an uplink (UL) sub-band and a downlink (DL) sub-band; receiving an indication to switch from SBFD operations to non-SBFD operations; and communicating with the base station based on non-SBFD operations in response to the indication.

Other processes, machines, and articles of manufacture are also described hereby, which may be combined in any number of ways, such as with the embodiments of the brief summary, without departing from the scope of this disclosure.

### BRIEF DESCRIPTION OF THE DRAWINGS

The present disclosure is illustrated by way of example and not limitation in the figures of the accompanying drawings in which like references indicate similar elements. To easily identify the discussion of any particular element or act, the most significant digit or digits in a reference number refer to the figure number in which that element is first introduced.

FIG. 1 illustrates an example wireless communication system according to some embodiments.

FIG. 2 illustrates a base station (BS) in communication with a user equipment (UE) device according to some embodiments.

FIG. 3 illustrates an example block diagram of a UE according to some embodiments.

FIG. 4 illustrates an example block diagram of a BS according to some embodiments.

FIG. 5 illustrates an example block diagram of cellular communication circuitry according to some embodiments.

FIG. 6 illustrates an example block diagram of a network message according to some embodiments.

FIG. 7 illustrates exemplary communications between full-duplex base stations and half-duplex UEs according to some embodiments.

FIG. 8 illustrates various aspects of an exemplary SBFD communication scheme according to some embodiments.

FIG. 9 illustrates various aspects of an exemplary non-SBFD communication scheme according to some embodiments.

FIG. 10 illustrates various aspects of collision handling according to some embodiments.

FIG. 11 illustrates various aspects of collision handling according to some embodiments.

FIG. 12 illustrates various aspects of switching to non-SBFD within a SFBD slot allocation according to some embodiments.

FIG. 13 illustrates a logic flow of an exemplary technique for collision handling according to some embodiments.

FIG. 14 illustrates a logic flow of an exemplary technique for switching from SFBD operations to non-SBFD operations according to some embodiments.

### DETAILED DESCRIPTION

Techniques for supporting sub-band full-duplex (SBFD) wireless communications are described. In the following description, numerous specific details are set forth to provide thorough explanation of embodiments of the present disclosure. It will be apparent, however, to one skilled in the art, that embodiments of the present disclosure may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the disclosure. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etcetera), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

Generally, this disclosure describes techniques for supporting SBFD wireless communications. More specifically, embodiments are directed to supporting SBFD wireless communications between full-duplex base stations and half-duplex UEs with SFBD awareness.

Some embodiments are directed to collision handling, such as when a half-duplex UE is scheduled to receive and transmit simultaneously on DL and UL sub-bands. In some such embodiments, UL grants, DL grants, and dynamic grants may be assigned different priority levels and cancellation timelines may be utilized to prioritize different grant types (e.g., by causing scheduled communications corresponding to grants with lower priority to be dropped). For example, dynamic grants may be prioritized first. However, if the UL and DL grants are both dynamic, or neither are dynamic, then UL grants may be prioritized. In another example, UL grants may be prioritized over DL grants, regardless of whether they are dynamic grants. In yet another example, DL grants may be prioritized over UL grants, regardless of whether they are dynamic grants.

Many embodiments are directed to switching to non-SBFD operation, such as within a SBFD slot allocation. In many such embodiments, SBFD aware UEs may receive indications to switch to non-SBFD operation, such as for a number of slots and/or period of time. For example, the indication may include a dynamic DL grant that schedules DL reception within a non-DL sub-band. In another example, the indication may comprise a new information element, such as in a downlink control information (DCI) message. In yet another example, the indication may be based on a time gap between the end of DCI scheduling a DL grant and a start of a dynamic DL grant exceeding a threshold. In some embodiments, the duration of the non-SBFD operation may also be indication. For instance, the UE may fall back to non-SBFD operation for an indicated number of slots after the indication to switch. It will be appreciated that various aspects of telecommunication networks, capabilities, protocols, and procedures relevant to the techniques described and terms referenced herein can be found in 3GPP technical specifications (TS), such as TS 38.213, TS 38.214, and TS 38.211.

The subject matter described hereby provides many technical advantages. For instance, the computer-based techniques of the current disclosure improve the functioning of a telecommunications system as compared to conventional approaches because the techniques enable robust support for SBFD that can improve accessibility and efficiency of telecommunication networks, reduce congestion, and provide expanded capabilities versus conventional approaches. For example, SBFD operations enable base stations to simultaneously transmit and receive, enabling available radio resources to support more UEs. Additionally, SBFD operations can provide more opportunities for UL and/or DL transmissions. For instance, each SBFD slot can include bandwidth for one or more UL transmissions and/or bandwidth for one or more DL transmissions instead of only including bandwidth for UL or DL transmissions. In another example, the ability to dynamically switch between SBFD and non-SBFD operations can enable more accessible and efficient networks. In such examples, SBFD operations can be utilized when additional UL capacity is needed and non-SBFD operations can be utilized when additional DL capacity is needed. Accordingly, embodiments disclosed hereby can be practically utilized to improve the functioning of a computer and/or to improve the technical fields of telecommunications, 5G networks, and/or sub-band full-duplex communications.

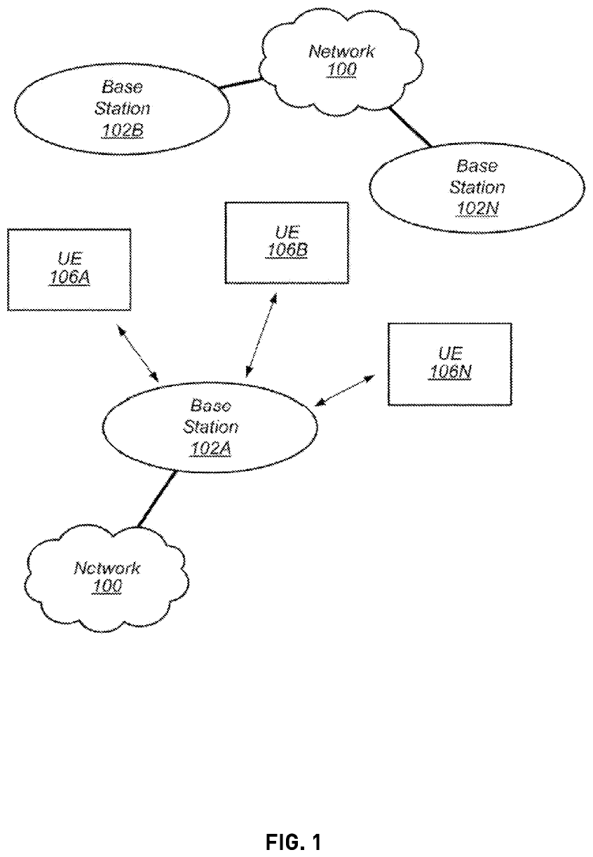

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etcetera, through 106N. Each of the user devices may be referred to herein as a “user equipment” (UE) or UE device. Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP 2 CDMA 2000 (e.g., 1xRTT, 1xEV-DO, HRPD, eHRPD), etcetera. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’. A next generation eNB (ng-eNB) may comprise an enhanced version of eNB that connects 5G UE to 5G core network using 4G LTE air interface.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services. It will be appreciated that in various embodiments, the term network may be utilized to collectively refer to one or more devices and components that form the telecommunications network. For example, reference to the network sending or receiving data to/from a UE may refer to one or more portions of the core network of a cellular service provider and/or one or more base stations. In some such examples, data to send to the UE may be determined by core network components and then relayed to the UE via a base station. In other such examples, data to send to the UE may be determined and sent to the UE by a base station.

Base station 102A and other similar base stations (such as base stations 102B . . .102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA 2000 (e.g., 1xRTT, 1xEV-DO, HRPD, eHRPD), etcetera). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

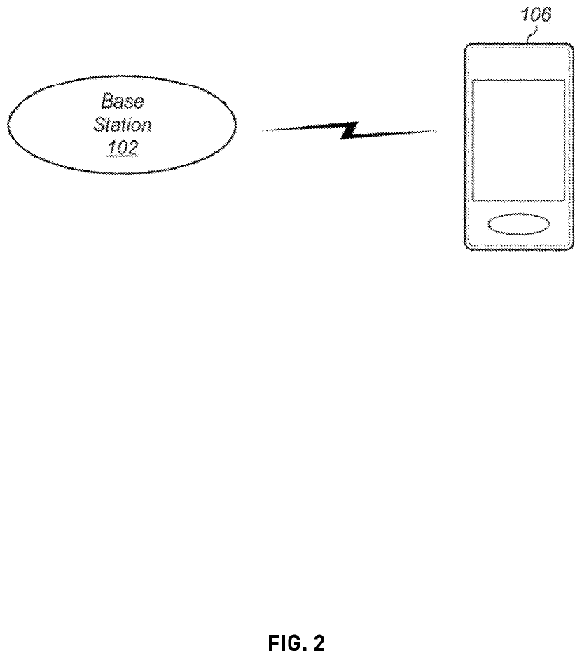

FIG. 2 illustrates user equipment 106 (e.g., one of the devices 106A through 106N) in communication with a base station 102, according to some embodiments. The UE 106 may be a device with cellular communication capability such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, 5G NR, CDMA 2000 (1xRTT/1xEV-DO/HRPD/eHRPD), or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1xRTTor LTE or GSM), and separate radios for communicating using each of Wi-Fi and Bluetooth. Other configurations are also possible.

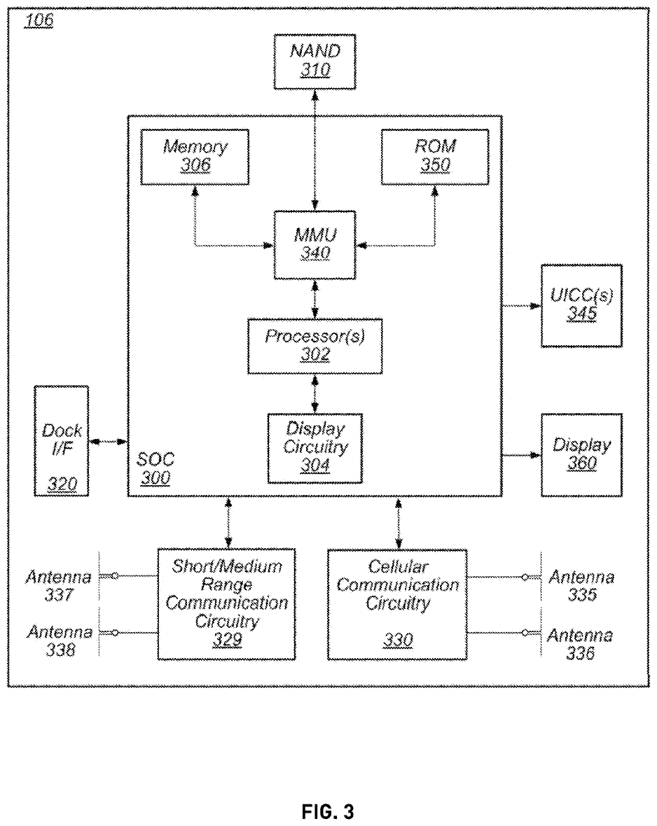

FIG. 3 illustrates an example simplified block diagram of a communication device 106, according to some embodiments. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly, dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may be configured to transmit a request to attach to a first network node operating according to the first RAT (e.g., 5G NR, 4G LTE, Bluetooth, Wi-Fi, etcetera) and transmit an indication that the wireless device is capable of maintaining substantially concurrent connections with the first network node and a second network node that operates according to the second RAT (e.g., 5G NR, 4G LTE, Bluetooth, Wi-Fi, etcetera). The wireless device may also be configured transmit a request to attach to the second network node. The request may include an indication that the wireless device is capable of maintaining substantially concurrent connections with the first and second network nodes. Further, the wireless device may be configured to receive an indication that dual connectivity with the first and second network nodes has been established.

As described herein, the communication device 106 may include hardware and software components for implementing the above features for supporting SBFD wireless communications. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etcetera) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etcetera) configured to perform the functions of cellular communication circuitry 330. Similarly, the short range wireless communication circuitry 329 may include one or more ICs that are configured to perform the functions of short range wireless communication circuitry 329. In addition, each integrated circuit may include circuitry (e.g., first circuitry, second circuitry, etcetera) configured to perform the functions of short range wireless communication circuitry 329.

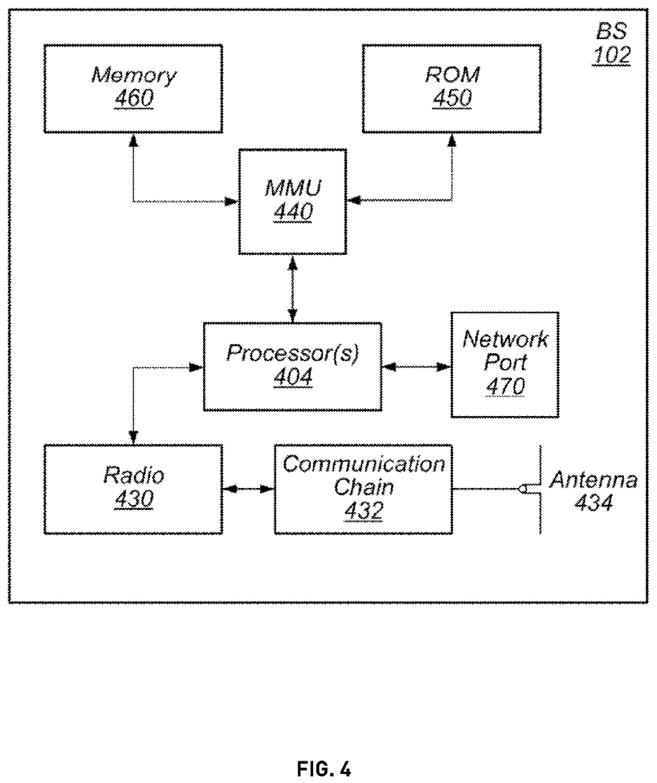

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

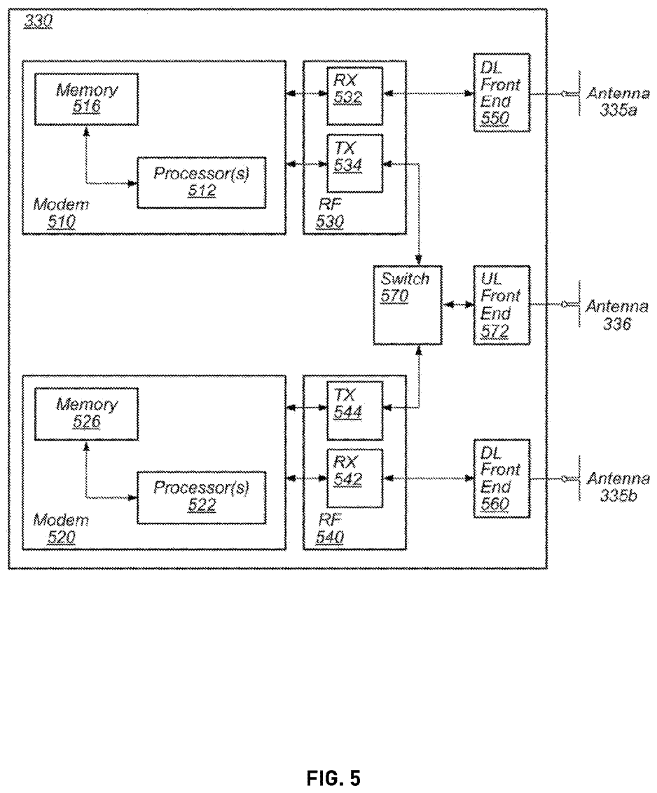

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 330 may be include in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335 a-b and 336 as shown. In some embodiments, cellular communication circuitry 330 may include dedicated receive chains (including and/or coupled to, e.g., communicatively; directly or indirectly, dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for supporting SBFD wireless communications, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etcetera) configured to perform the functions of processors 512.

As described herein, the modem 520 may include hardware and software components for implementing the above features for supporting SBFD wireless communications, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etcetera) configured to perform the functions of processors 522.

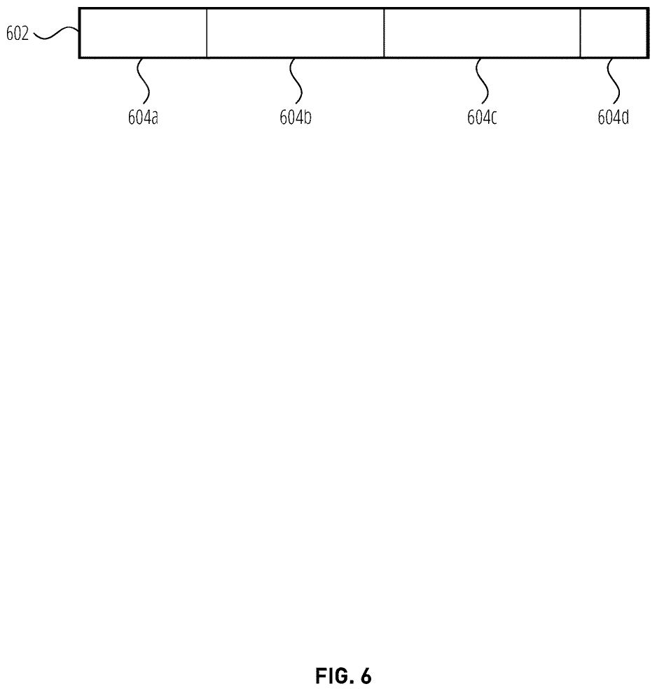

FIG. 6 illustrates a network message 602 comprising a plurality of information elements (IEs) 604a, 604b, 604c, 604d (collectively referred to as IEs 604). In various embodiments, a variety of network messages 602 composed of one or more information elements may be utilized for communication between different components. In various such embodiments, one or more network messages 602 of one or more formats may be exchanged between the one or more UEs and one or more network components to perform one or more procedures or techniques disclosed hereby. For example, indications for switching between SFBD and non-SFBD operations may be carried in network messages. In some such examples, as will be described in more detail below, the timing of network messages may be utilized as indications. It will be appreciated that the network message 602 and IEs 604 may come in a variety of formats and carry a variety of information. Oftentimes, various standards and technical specifications define the various network messages 602, IEs 604, and procedures, such as 3GPP technical specifications (e.g., TS 38.213, TS 38.214, and TS 38.211). Embodiments are not limited in this context.

Various techniques for supporting SBFD wireless communications in cellular networks will be described in more detail below. Unless otherwise stated, embodiments described hereby are directed to supporting SBFD wireless communications between full-duplex base stations and half-duplex UEs. Further, unless indicated otherwise, although the UEs are not able to simultaneously transmit and receive, they are aware of SFBD operations and able to utilize non-SFBD and SFBD operations.

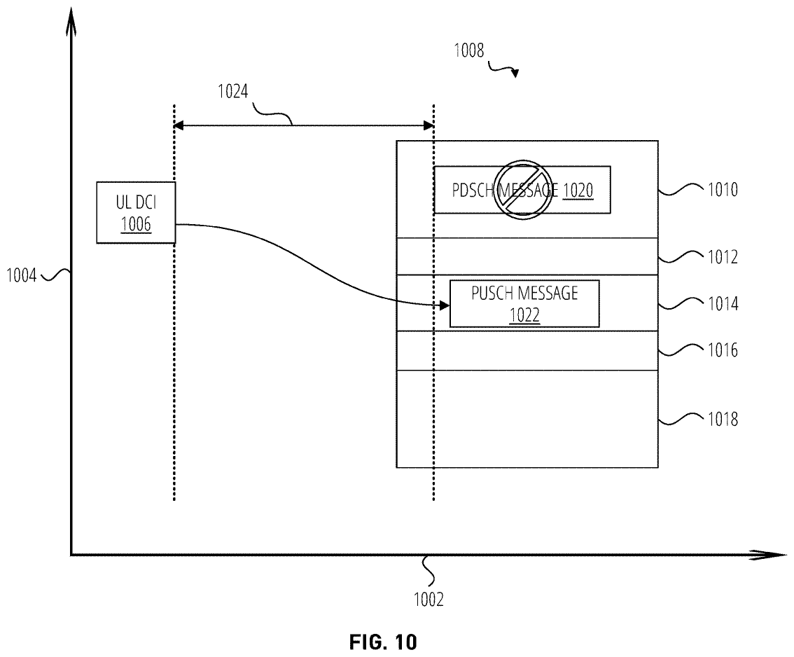

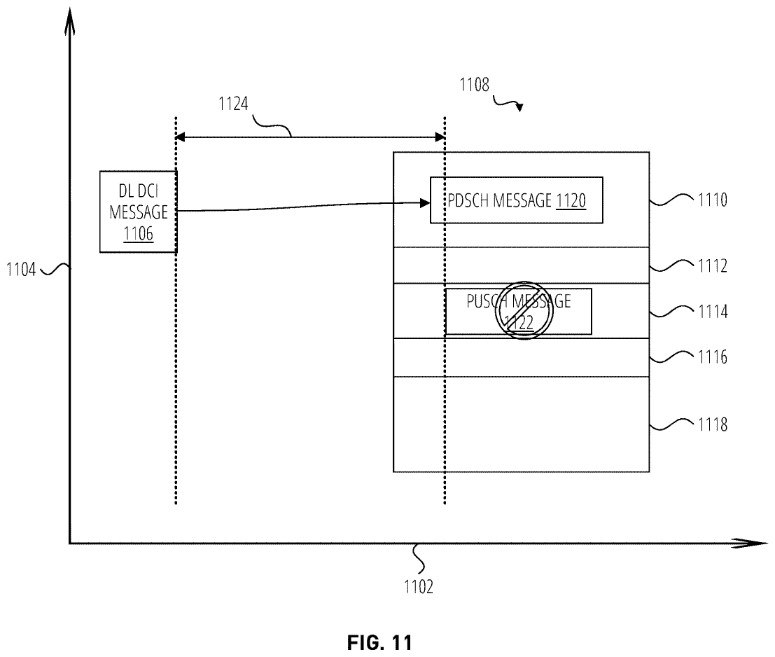

Some embodiments are directed to collision handling, such as when a half-duplex UE is scheduled to receive and transmit simultaneously on DL and UL sub-bands (see e.g., FIGS. 10 and 11). In some such embodiments, UL grants, DL grants, and dynamic grants may be assigned different priority levels and cancellation timelines may be utilized to prioritize different grant types (e.g., by causing scheduled communications corresponding to grants with lower priority to be dropped). For example, dynamic grants may be prioritized first. However, if the UL and DL grants are both dynamic, or neither are dynamic, then UL grants may be prioritized. In another example, UL grants may be prioritized over DL grants, regardless of whether they are dynamic grants. In yet another example, DL grants may be prioritized over UL grants, regardless of whether they are dynamic grants.

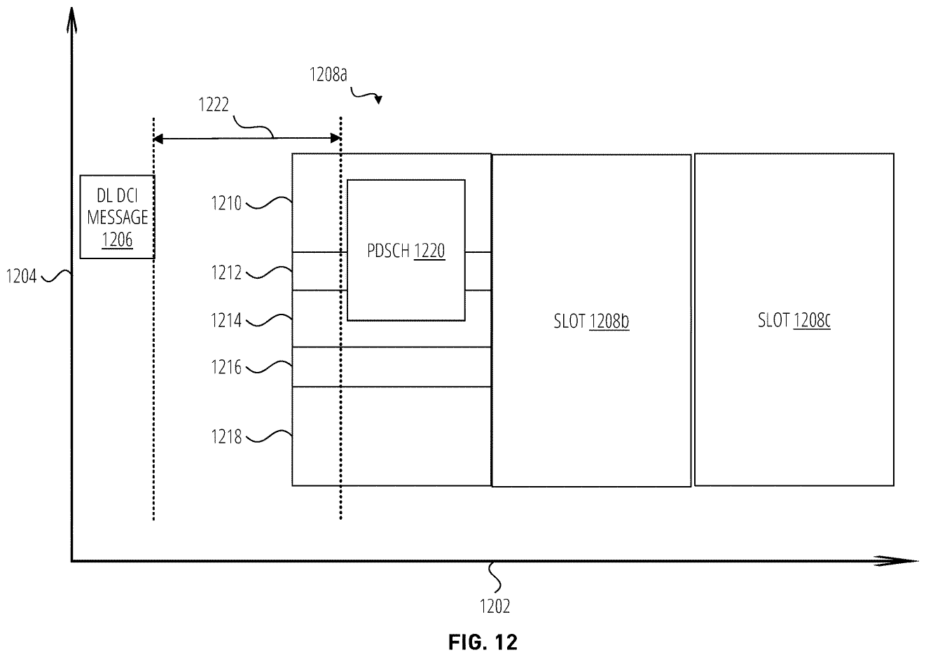

Many embodiments are directed to switching to non-SBFD operation, such as within a SBFD slot allocation (see e.g., FIG. 12). In many such embodiments, SBFD aware UEs may receive indications to switch to non-SBFD operation, such as for a number of slots and/or period of time. For example, the indication may include a dynamic DL grant that schedules DL reception within a non-DL sub-band. In another example, the indication may comprise a new information element, such as in a downlink control information (DCI) message. In yet another example, the indication may be based on a time gap between the end of DCI scheduling a DL grant and a start of a dynamic DL grant exceeding a threshold. In some embodiments, the duration of the non-SBFD operation may also be indication.

For instance, the UE may fall back to non-SBFD operation for an indicated number of slots after the indication to switch. In various embodiments, switching from SBFD operation (or SBFD configuration) may be referred to as overriding the SBFD configuration or falling back to non-SBFD. In several embodiments, this could include scenarios in which the configured/indicated SBFD symbol is not used (e.g., there is no UE to be critically scheduled in UL within UL sub-band in SBFD symb01). In several such embodiments, the scheduler may schedule UEs in DL even in UL sub-bands (i.e., scheduler switches back to non-SBFD symbol.

The computer-based techniques of the current disclosure improve the functioning of a telecommunications system as compared to conventional approaches because the techniques enable robust support for SBFD that can improve accessibility and efficiency of telecommunication networks, reduce congestion, and provide expanded capabilities versus conventional approaches in a manner that improves the technical fields of telecommunications, 5G networks, and/or sub-band full-duplex communications. In many embodiments, SBFD operations enable base stations to simultaneously transmit and receive, enabling available radio resources to support more UEs. Additionally, SBFD operations can provide more opportunities for UL and/or DL transmissions. For example, each SBFD slot can include bandwidth for one or more UL transmissions and/or bandwidth for one or more DL transmissions. In many embodiments, the ability to dynamically switch between SBFD and non-SBFD operations can enable more accessible and efficient networks. In such examples, SBFD operations can be utilized when additional UL capacity is needed and non-SBFD operations can be utilized when additional DL capacity is needed.

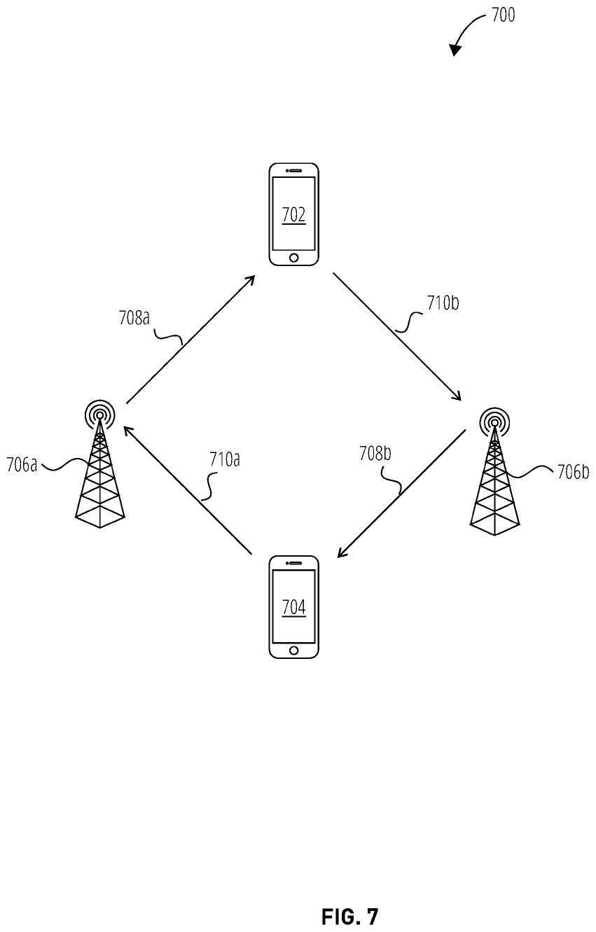

FIG. 7 illustrates exemplary communications between full-duplex base stations and half-duplex UEs according to some embodiments. FIG. 7 includes an operating environment 700 with UE 702, UE 704, base station 706a, and base station 706b. In the illustrated embodiment, base station 706a may simultaneously receive uplink message 710a from UE 704 and transmit downlink message 708a to UE 702. At another point in time, base station 706b may simultaneously receive uplink message 710b from UE 702 and transmit downlink message 708b to UE 704. These uplink and/or downlink messages may be utilized for communication between UEs and base stations, such as for SFBD communications. Further, the simultaneous uplink and downlink communications by base station 706a and base station 706b occur at different times due to UEs 702, 704 being half-duplex. Accordingly, base stations 706a, 706b may both simultaneously transmit and receive at the same time as each other; however, in the illustrated embodiment, it would result in a collision due to the UEs 702, 704 being half duplex. It is with respect to this and similar scenarios that various collision handling and/or avoidance embodiments disclosed hereby are typically directed to. Embodiments are not limited in this context.

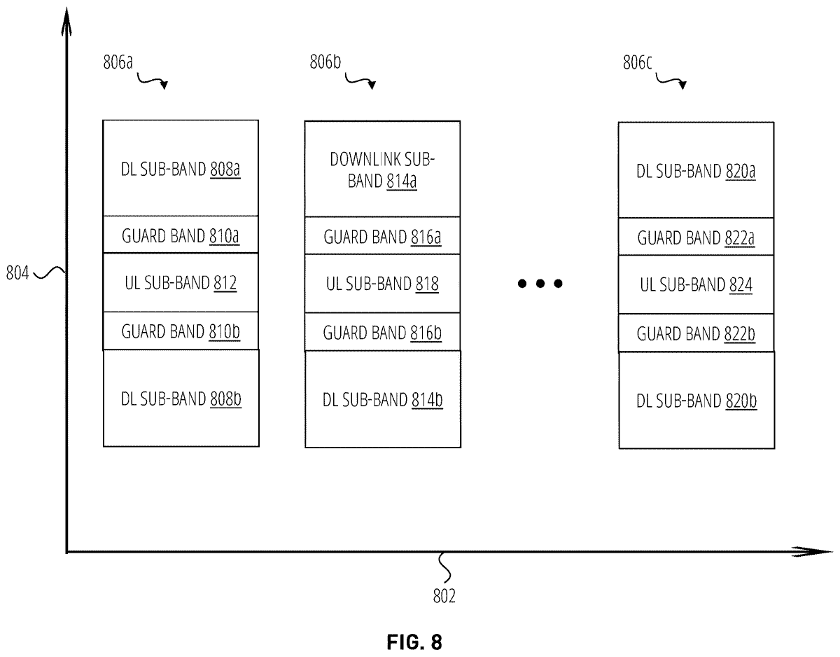

FIG. 8 illustrates various aspects of an exemplary SBFD communication scheme according to some embodiments. In the illustrated embodiments, a set of one or more SBFD slots 806a, 806b, 806c (collectively referred to as SBFD slots 806) are shown with a time dimension 802 and a frequency dimension 804. The SBFD slot 806a includes a DL sub-band 808a, guard band 810a, UL sub-band 812, guard band 810b, and DL sub-band 808b. The SBFD slot 806b includes downlink sub-band 814a, guard band 816a, UL sub-band 818, guard band 816b, and DL sub-band 814b. The SBFD slot 806c includes DL sub-band 820a, guard band 822a, UL sub-band 824, guard band 822b, and DL sub-band 820b. In the illustrated embodiments, each of the SFBD slots 806 occur during a unique period of time and share a common frequency band with common frequency sub-bands. However, these timing and frequency aspects are merely exemplary and not limiting. Accordingly, a variety of timing and frequency configurations may be utilized without departing from the scope of this disclosure.

In SBFD slots 806, UEs may be scheduled to send (uplink) and/or receive (downlink) via the various sub-bands in the various slots. For example, a first UE may be scheduled to send a UL message in UL sub-band 812 and the first UE may be scheduled to receive a DL message in DL sub-band 820b. In some additional embodiments, a second UE may be scheduled to receive a DL message in DL sub-band 808a and the second UE may be scheduled to send a UL message in UL sub-band 824. In many embodiments, UEs may request UL and/or DL scheduling. Similarly, the network (e.g., a base station) may request UL and/or DL scheduling as well as communicate schedules to UEs. In several embodiments, DCI network messages may be utilized to schedule UEs. A UL grant may refer to a notification of a scheduled UL communication. A DL grant may refer to a notification of a scheduled DL communication. The guard bands 810a, 810b, 816a, 816b, 822a, 822b (collectively referred to as guard bands 810) may be utilized to separate the frequency sub-bands for UL and DL communications. In some embodiments, a slot may be the same or similar to a symbol. In some such embodiments, a symbol may correspond to a specific slot or portion of a slot and/or a specific configuration. For example, there may be 14 symbols within a slot.

More generally, in various embodiments, SBFD operation or SBFD configuration may refer to, or be based on, the use of orthogonal frequency division multiplexing (OFDM). With OFDM, in the frequency domain, multiple adjacent subcarriers may each be independently modulated with complex data. An inverse Fast Fourier Transform (FFT) may be performed on the frequency-domain subcarriers to produce the OFDM symbol in the time-domain. Then in the time domain, guard intervals may be inserted between each of the symbols to prevent inter-symbol interference at the receiver caused by multi-path delay spread in the radio channel. Multiple symbols may be concatenated to create the final OFDM burst signal. At the receiver an FFT may be performed on the OFDM symbols to recover the original data bits.

A collision may occur when a half-duplex UE is scheduled to transmit and receive in the same slot or within too short of a time period. For example, a UE scheduled to transmit during UL sub-band 818 and receive during downlink sub-band 814a would result in a collision. In various embodiments, too short of a time period may be based on device capabilities. For example, a UE may require a certain amount of time between sending and receiving network messages due to hardware and/or software capabilities. Accordingly, in some embodiments, a collision may occur when a UE is scheduled to transmit in UL sub-band 812 of SBFD slot 806a and receive in DL sub-band 814b of SBFD slot 806b. Collision handling or collision avoidance may refer to techniques utilized to manage scenarios in which a UE is scheduled to transmit and receive within too short of a time period, such as prioritization and cancellation timelines.

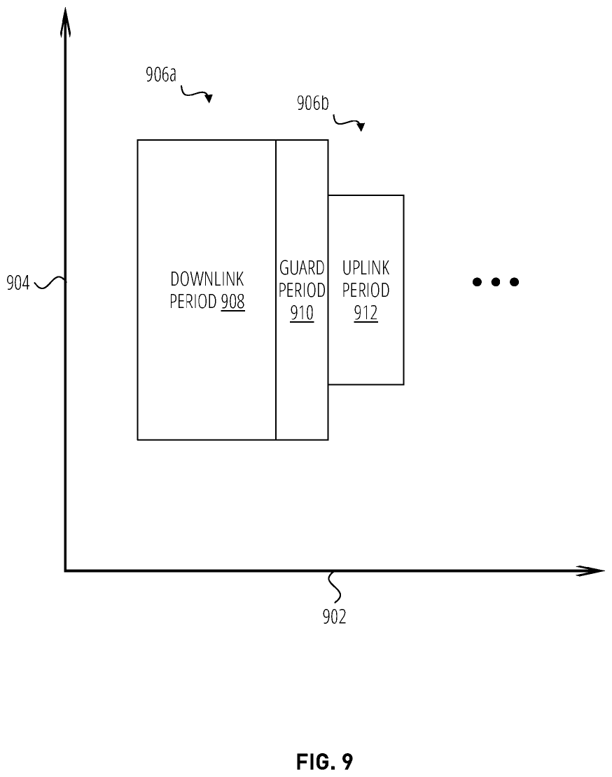

FIG. 9 illustrates various aspects of an exemplary non-SBFD communication scheme according to some embodiments. In the illustrated embodiments, a set of one or more non-SBFD slots 906a, 906b (collectively referred to as non-SBFD slots 906) are shown with a time dimension 902 and a frequency dimension 904. The non-SBFD slot 906a includes a downlink period 908 and the non-SBFD slot 906b includes an uplink period 912. The downlink period 908 is separated from the uplink period 912 with a guard period 910. In alternative embodiments, a single non-SBFD slot may include the downlink period 908, the guard period 910 and the uplink period 912. In non-SBFD slots 906, UEs may be scheduled to send (uplink) and/or receive (downlink) via the various time periods. For example, a UE may be scheduled to send a UL message in UL sub-band 812 and the UE may be scheduled to receive a DL message in DL sub-band 820b. In some embodiments, non-SPFD operations may utilize TDD. In the illustrated embodiments, each of the non-SFBD slots 906 occur during a unique period of time. However, these timing aspects are merely exemplary and not limiting. Accordingly, a variety of timing configurations may be utilized without departing from the scope of this disclosure.

FIG. 10 illustrates various aspects of collision handling according to some embodiments. In the illustrated embodiment, a UL DCI 1006 and an SBFD slot 1008 are shown with a time dimension 1002 and a frequency dimension 1004. The SBFD slot 1008 includes a DL sub-band 1010, a guard band 1012, a UL sub-band 1014, a guard band 1016, and a DL sub-band 1018. Additionally, the SBFD slot 1008 includes a physical downlink shared channel (PDSCH) message 1020 that is scheduled but dropped and a physical uplink shared channel (PUSCH) message 1022 that is scheduled and sent.

Accordingly, in this embodiment, UL grants are prioritized over DL grants with the DL grants being dropped pursuant a cancellation timeline. In several embodiments, the prioritized grant may be referred to as the primary grant and the other grant may be referred to as the secondary grant. Embodiments are not limited in this context.

As previously mentioned, collision handling may be needed when a half-duplex UE is scheduled to transmit and receive at the same time, such as when within a SBFD symbol. The illustrated embodiment shows a UE scheduled to transmit PUSCH message 1022 and receive PDSCH message 1020 within the SBFD slot 1008. In many embodiments, UL DCI 1006 comprises a dynamic grant.

In FIG. 10, the UL grant message (PUSCH message 1022) is prioritized, and the UE drops the scheduled DL grant message (PDSCH message 1020). In such scenarios, the UE may not expect a dynamic DL grant to be received which schedules a DL reception overlapping with a UL transmission. Accordingly, a cancellation timeline to prioritize UL grants and drop DL grant messages can be defined, such as based on UE capability and/or a minimum sub carrier spacing (SCS). In such a cancellation timeline, the time duration between the last symbol of DCI scheduling the UL grant (e.g., UL DCI 1006) and the first symbol of the DL grant (e.g., PDSCH message 1020) may not be less than the time period 1024. In several embodiments, cancellation timelines may include repetitions also. In some embodiments, the time period 1024 may be based on device capability, such as UE capability (e.g., hardware/software capability). For example, time period 1024 may be based on UE capability and minimum sub-carrier spacing (e.g., of DCI, DL grant, UL grant). In various embodiments, the time period 1024 may be fixed, such as fixed at 14 symbols.

In many embodiments, the cancellation timeline may be defined from the last symbol of DCI cancelling another grant to the first symbol of the canceled grant. In many such embodiments, the cancellation timeline may be defined based on the minimum of the SCS of DIC and the SCS of the grant that will be cancelled. In further such embodiments, there may be different values for each minimum based on UE capability. For example, with a minimum SCS of 15 kHz, a first UE may require, based on the capability of the first UE, 10 symbols in 15 kHz SCS for cancellation of the low priority grant and a second UE may require, based on the capability of the second UE, 5 symbols in 15 kHz SCS for cancellation of the low priority grant.

FIG. 11 illustrates various aspects of collision handling according to some embodiments. In the illustrated embodiment, a DL DCI message 1106 and an SBFD slot 1108 are shown with a time dimension 1102 and a frequency dimension 1104. The SBFD slot 1108 includes a DL sub-band 1110, a guard band 1112, a UL sub-band 1114, a guard band 1116, and a DL sub-band 1118. Additionally, the SBFD slot 1008 includes a PUSCH message 1122 that is scheduled but dropped and a PDSCH message 1120 that is scheduled and sent. Accordingly, in this embodiment, DL grants are prioritized over UL grants with the UL grants being dropped pursuant a cancellation timeline. In many embodiments, the prioritized grant may be referred to as the primary grant and the other grant may be referred to as the secondary grant. Embodiments are not limited in this context.

In scenarios such as the illustrated embodiment, the UE may not expect a dynamic UL grant to be received after a UL grant is schedule. In such embodiments, a dynamic UL grant may override a UL grant when the UL cancellation timeline is met. In many embodiments, DL DCI message 1106 comprises a dynamic grant. Accordingly, a cancellation timeline can be defined to prioritize UL grants and drop DL grant messages, such as based on UE capability and/or minimum SCS (e.g., as described above). In such a cancellation timeline, the time duration between the last symbol of DCI scheduling the DL grant (e.g., DL DCI message 1106) and the first symbol of the UL grant (e.g., PUSCH message 1122) may not be less than the time period 1124. In several embodiments, cancellation timelines may include repetitions also. In some embodiments, the time period 1024 may be based on device capability, such as UE capability (e.g., hardware/software capability). For example, time period 1124 may be based on a period of time that the UE takes to process a received PDSCH message. For instance, the cancellation timeline may be based on twice the period of time that the UE takes to process a received PDSCH message. In some such instance, the time period 1124 may comprise twice the period of time the UE takes to process a received PDSCH message plus a positive constant, D. In various embodiments, D may correspond to zero or more symbols. In several embodiments, D may be defined as a function of SCS and UE capability (e.g., as described with respect to cancellation timelines above). In several such embodiments, D may additionally, or alternatively, be defined based on where demodulation reference signals (DMRSs) are located within the grant, whether data is multiplexed with DMRS, etcetera.

In many embodiments, instead of prioritizing UL grants or DL grants, dynamic grants can be prioritized, such as via cancellation timelines. In many such embodiments, if both grants are dynamic, or neither grant is dynamic, then a predefined rule may prioritize either UL or DL grants. For example, if both UL and DL grants are dynamic, then UL grants may be prioritized. In several embodiments, UL grants may generally be prioritized over DL grants due to the comparatively lower amount of resources (e.g., bandwidth) allocated to UL communications. Regardless of how grants are prioritized, cancellation timelines may be utilized to drop secondary grants in favor of primary grants.

FIG. 12 illustrates various aspects of switching to non-SBFD within a SFBD slot allocation according to some embodiments. In many embodiments, a SBFD aware UE can be dynamically indicated to fall back to non-SBFD operation, such as legacy time division duplex (TDD) operations. In the illustrated embodiment a DL DCI message 1206 and a set of one or more slots 1208a, 1208b, 1208c are shown with a time dimension 1202 and a frequency dimension 1204. The slot 1208a includes a DL sub-band 1210, a guard band 1212, a UL sub-band 1214, a guard band 1216, and a DL sub-band 1218. Slots 1208a, 1208b include legacy slots. In various embodiments, legacy slots may refer to non-SBFD slots within an SFBD slot allocation. In several embodiments, each of the non-SBFD slots may comprise flexible non-SBFD symbols. Embodiments are not limited in this context.

In various embodiments, switching from SBFD operation (or SBFD configuration) may be referred to as overriding the SBFD configuration or falling back to non-SBFD. In several embodiments, this could include scenarios in which the configured/indicated SBFD symbol is not used (e.g., there is no UE to be critically scheduled in UL within UL sub-band in SBFD symb01). In several such embodiments, the scheduler may schedule UEs in DL even in UL sub-bands (i.e., scheduler switches back to non-SBFD symbol. Similar to cancellation timelines, fallback timelines may be defined and adhered to for fallback operation.

A variety of techniques may be utilized to provide an indication to a UE to switch from SBFD operation to non-SBFD operation. In some embodiments, the indication may include an implicit indication. In some such embodiments, a dynamic DL grant that schedules DL reception within a UL sub-band and/or guard-band may be used to provide an indication to fall back to non-SBFD operation. In various embodiments, the indication may include an explicit indication. In various such embodiments, a new information element or flag may be included, such as in a DL (or UL) DCI message that indicates to fall back to non-SBFD operation. In several embodiments, a group common DCI (GC-DCI) may be used to indicate to a UE to fall back to non-SBFD operation. In some embodiments, the indications may be broadcast or multicast to a plurality of UEs. In other embodiments, the indications may be unicast to specific UEs.

Some embodiments may introduce a UE capability to dynamically indicate switching to non-SBFD operation within an SBFD allocation. For instance, the dynamic indication may be based on whether a time gap between the end of DCI scheduling a dynamic grant (e.g., DL grant) and the start of the dynamic grant (e.g., PDSCH 1220) exceeds a threshold (e.g., time period 1222). In various embodiments, the time period 1222 (and subsequent fallback timeline) may be defined based on minimum SCS and/or UE capability. For example, the fallback timeline can depend on the minimum of the SCS of DCI and the SCS of PDSCH. In some embodiments, there may be different values for each minimum based on UE capability. For example, with a minimum SCS of 15kHz for DL, a first UE may require, based on the capability of the first UE, 2 symbols in 15kHz SCS and a second UE may require, based on the capability of the second UE, 4 symbols in 15kHz SCS.

In the illustrated embodiment, the overlap of PDSCH 1220 with guard band 1212 and UL sub-band 1214 may be illustrative of an implicit indication. However, usage of the implicit indication regarding the time period 1222 as shown in FIG. 12 may occur regardless of whether PDSCH 1220 overlaps guard band 1212 and/or UL sub-band 1214. In other words, when an explicit indication is used, overlap with other sub-bands may or may not be simultaneously utilized.

Once the UE is indicated to all back to non-SBFD, the UE may determine the length of non-SBFD operation using a variety of techniques. In some embodiments, the duration may comprise the SBFD slots that span the dynamic DL grant and its repetitions. In some such embodiments, the duration may comprise the SBFD slots that span the dynamic DL grant and its repetitions plus the PUCCH messages for hybrid automatic repeat request acknowledgement (HARQ-ACK). In other embodiments, the duration may comprise the slot that the dynamic DL grant starts until an indicated number, K, of slots afterwards. In the illustrated embodiment, K may equal two. In other such embodiments, the number, K, may be indicated via radio resource control (RRC) communications.

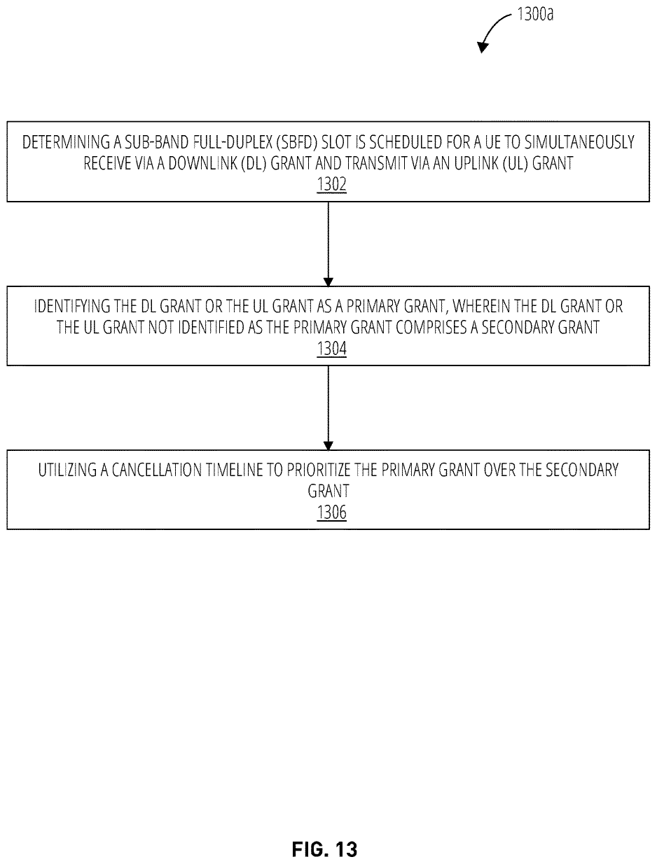

FIG. 13 illustrates a logic flow 1300 of an exemplary technique for obtaining an updated positioning configuration according to some embodiments. Aspects of logic flow 1300 may relate to various embodiments described hereby. Logic flow 1300 may begin at block 1302. Block 1302 may include determining a sub-band full-duplex slot is scheduled for a UE to simultaneously receive based on a downlink (DL) grant and transmit based on an uplink (UL) grant. For example, UE 702 may be scheduled to simultaneously transmit and receive based on UL and DL grants, respectively. In many such embodiments, UE 702 may determine it is scheduled to simultaneously transmit and received based on one or more DCI network messages (e.g., UL DCI 1006 and/or DL DCI message 1106).

Continuing to block 1304, the DL grant or the UL grant may be identified as a primary grant and the DL or UL grant not identified as the primary grant may comprise a secondary grant. For example, UE 702 may be scheduled to simultaneously transmit and receive in SBFD slot 1008 and, in response, the uplink transmission (e.g., PUSCH message 1022) may be identified as the primary grant and the downlink transmission (e.g., PDSCH message 1020) may comprise the secondary grant.

Proceeding to block 1306, a cancellation timeline may be utilized to prioritize the primary grant over the secondary grant. For example, adherence to the cancellation timeline may cause the downlink transmission (e.g., PDSCH message 1020) to be dropped and the uplink transmission (e.g., PUSCH message 1022) to be sent.

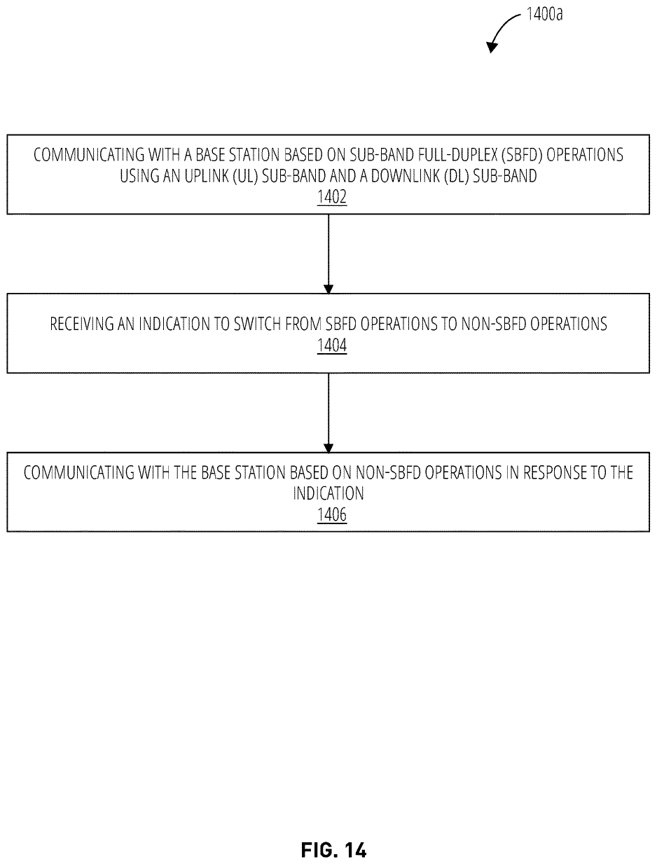

FIG. 14 illustrates a logic flow 1400 of an exemplary technique for switching from SFBD operations to non-SBFD operations according to some embodiments. Aspects of logic flow 1400 may relate to various embodiments described hereby. Logic flow 1400 may begin at block 1402. Block 1402 may include communicating with a base station based on sub-band full-duplex (SBFD) operations using an uplink (UL) sub-band and a downlink (DL) sub-band. For example, UE 704 may communicate with base station 706b based on SFBD operations using DL sub-band 808a in SBFD slot 806a and UL sub-band 824 in SBFD slot 806c.

Continuing to block 1404, an indication to switch from SBFD operations to non-SBFD operations may be received. For example, DL DCI message 1206 may include an indication to switch from SBFD operations to non-SBFD operations. In a further, or alternative example, a dynamic DL grant may schedule DL reception within UL sub-bands and/or guard bands (see e.g., PDSCH 1220 overlapping DL sub-band 1210, guard band 1212, and UL sub-band 1214). Proceeding to block 1406, in response to the indication, non-SBFD operations may be utilized to communicate with the base station. For example, slots 1208b, 1208c may utilize non-SBFD operations. In many embodiments, the non-SBFD operations may occur within a SBFD slot (e.g., slots 1208a, 1208b).

Portions of what was described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present disclosure also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etcetera.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMS, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

There are a number of example embodiments described herein.

Example 1 is a computer-implemented method, comprising determining a sub-band full-duplex (SBFD) slot is scheduled for a UE to simultaneously receive based on a downlink (DL) grant and transmit based on an uplink (UL) grant; identifying the DL grant or the UL grant as a primary grant, wherein the DL grant or the UL grant not identified as the primary grant comprises a secondary grant; and prioritizing the primary grant over the secondary grant using a cancellation timeline in response to the SBFD being scheduled for the UE to simultaneously receive based on the DL grant and transmit based on the UL grant.

Example 2 is the computer-implemented method of Example 1 that may optionally include determining the DL grant or the UL grant is a dynamic grant; and identifying the dynamic grant as the primary grant.

Example 3 is the computer-implemented method of Example 2 that may optionally include determining the DL grant and the UL grant are dynamic grants; and prioritizing the UL dynamic grant.

Example 4 is the computer-implemented method of Example 1 that may optionally include determining the DL grant and the UL grant are not dynamic grants; and identifying the UL grant as the primary grant.

Example 5 is the computer-implemented method of Example 1 that may optionally include identifying the UL grant as the primary grant based on a predefined rule prioritizing UL grants over DL grants.

Example 6 is the computer-implemented method of Example 1 that may optionally include that the cancellation timeline is defined based on a minimum period of time between a last symbol of a downlink control information (DCI) message scheduling a UL grant and a first symbol of a DL grant.

Example 7 is the computer-implemented method of Example 6 that may optionally include that the minimum period of time between the last symbol of DCI scheduling a UL grant and the first symbol of the DL grant is determined based on UE capability.

Example 8 is the computer-implemented method of Example 6 that may optionally include that the minimum period of time between the last symbol of DCI scheduling a UL grant and the first symbol of the DL grant is predefined.

Example 9 is the computer-implemented method of Example 6 that may optionally include that the cancellation timeline is defined based on a minimum sub-carrier spacing of one or more of downlink control information (DCI), DL grant, and UL grant).

Example 10 is the computer-implemented method of Example 1 that may optionally include identifying the DL grant as the primary grant based on a predefined rule prioritizing DL grants over UL grants.

Example 11 is the computer-implemented method of Example 1 that may optionally include that the cancellation timeline is defined based on a period of time the UE requires to process a received physical downline shared channel (PDSCH) message.

Example 12 is the computer-implemented method of Example 11 that may optionally include that the cancellation timeline is defined based on twice the period of time.

Example 13 is the computer-implemented method of Example 11 that may optionally include that the cancellation timeline is defined based on twice the period of time plus a constant.

Example 14 is a user equipment (UE) comprising one or more processors configured to perform the computer-implemented method of any of Examples 1 to 13.

Example 15 is a non-transitory machine-readable medium having executable instructions to cause one or more processing units to perform the computer-implemented method of any of Examples 1 to 13.

Example 16 is a computer-implemented method, comprising scheduling a user equipment (UE) in a sub-band full-duplex (SBFD) slot to simultaneously receive based on a downlink (DL) grant and transmit based on an uplink (UL) grant; and causing the UE to utilize a cancellation timeline to prioritize the primary grant over the secondary grant in response to identifying the DL grant or the UL grant as a primary grant, wherein the DL grant or the UL grant not identified as the primary grant comprises a secondary grant.

Example 17 is the computer-implemented method of Example 16 that may optionally include determining the DL grant or the UL grant is a dynamic grant; and identifying the dynamic grant as the primary grant.

Example 18 is the computer-implemented method of Example 17 that may optionally include determining the DL grant and the UL grant are dynamic grants; and prioritizing the UL dynamic grant.

Example 19 is the computer-implemented method of Example 16 that may optionally include determining the DL grant and the UL grant are not dynamic grants; and identifying the UL grant as the primary grant.

Example 20 is the computer-implemented method of Example 16 that may optionally include identifying the UL grant as the primary grant based on a predefined rule prioritizing UL grants over DL grants.

Example 21 is the computer-implemented method of Example 16 that may optionally include that the cancellation timeline is defined based on a minimum period of time between a last symbol of a downlink control information (DCI) message scheduling a UL grant and a first symbol of a DL grant.

Example 22 is the computer-implemented method of Example 21 that may optionally include that the minimum period of time between the last symbol of DCI scheduling a UL grant and the first symbol of the DL grant is determined based on UE capability.

Example 23 is the computer-implemented method of Example 21 that may optionally include that the minimum period of time between the last symbol of DCI scheduling a UL grant and the first symbol of the DL grant is predefined.

Example 24 is the computer-implemented method of Example 21 that may optionally include that the cancellation timeline is defined based on a minimum sub-carrier spacing of one or more of downlink control information (DCI), DL grant, and UL grant).

Example 25 is the computer-implemented method of Example 16 that may optionally include identifying the DL grant as the primary grant based on a predefined rule prioritizing DL grants over UL grants.

Example 26 is the computer-implemented method of Example 16 that may optionally include that the cancellation timeline is defined based on a period of time the UE requires to process a received physical downline shared channel (PDSCH) message.

Example 27 is the computer-implemented method of Example 26 that may optionally include that the cancellation timeline is defined based on twice the period of time.

Example 28 is the computer-implemented method of Example 26 that may optionally include that the cancellation timeline is defined based on twice the period of time plus a constant.

Example 29 is a base station (BS) comprising one or more processors configured to perform the computer-implemented method of any of claims 16 to 28.

Example 30 is a non-transitory machine-readable medium having executable instructions to cause one or more processing units to perform the computer-implemented method of any of claims 16 to 28.

Example 31 is a computer-implemented method, comprising receiving communications from a base station based on sub-band full-duplex (SBFD) operations using a downlink (DL) sub-band; transmitting communications to the base station based on SBFD operations using an uplink (UL) sub-band; receiving an indication to switch from SBFD operations to non-SBFD operations; and transmitting communications to the base station based on non-SBFD operations in response to the indication.

Example 32 is the computer-implemented method of Example 31 that may optionally include that non-SBFD operations utilize legacy time division duplex (TDD) operations.

Example 33 is the computer-implemented method of Example 31 that may optionally include that the indication includes an implicit indication comprising a dynamic DL grant that schedules DL reception within the UL sub-band or a guard band.

Example 34 is the computer-implemented method of Example 31 that may optionally include that the indication includes an explicit indication comprising an information element in a DL downlink control information (DCI) message or an uplink DCI message.

Example 35 is the computer-implemented method of Example 31 that may optionally include that the indication includes an explicit indication comprising an information element in a group common downlink control information (GC-DCI) message.

Example 36 is the computer-implemented method of Example 31 that may optionally include that transmitting communications to the base station based on non-SBFD operations occurs within a SBFD allocation.

Example 37 is the computer-implemented method of Example 36 that may optionally include that the indication comprises a period of time between an end of a downlink control information (DCI) message scheduling a DL grant and a start of a dynamic DL grant exceeding a threshold period of time.

Example 38 is the computer-implemented method of Example 37 that may optionally include that the duration of the non-SBFD operations within the SBFD allocation comprises a number of slots.

Example 39 is the computer-implemented method of Example 38 that may optionally include that the number of slots comprises a number of SBFD slots that span the dynamic DL grant and corresponding repetitions.

Example 40 is the computer-implemented method of Example 38 that may optionally include that the number of slots comprises a number of SBFD slots that span the dynamic DL grant, corresponding repetitions, and physical uplink control channel messages for hybrid automatic repeat request acknowledgement (HARQ-ACK).

Example 41 is the computer-implemented method of Example 38 that may optionally include that the number of slots comprises a number of SBFD slots that span from the start of the dynamic DL grant and extend for an indicated number of slots.

Example 42 is the computer-implemented method of Example 41 that may optionally include that the indicated number of slots comprises a radio resource control (RRC) indicated number of slots.

Example 43 is a user equipment (UE) comprising one or more processors configured to perform the computer-implemented method of any of claims 31 to 42.

Example 44 is a non-transitory machine-readable medium having executable instructions to cause one or more processing units to perform the computer-implemented method of any of claims 31 to 42.

Example 45 is a computer-implemented method, comprising transmitting communications to a user equipment (UE) based on sub-band full-duplex (SBFD) operations using a downlink (DL) sub-band; receiving communications from the UE based on SBFD operations using an uplink (UL) sub-band; transmitting an indication to the UE to switch from SBFD operations to non-SBFD operations; and receiving communications from the UE based on non-SBFD operations in response to the indication.

Example 46 is the computer-implemented method of Example 45 that may optionally include that non-SBFD operations utilize legacy time division duplex (TDD) operations.

Example 47 is the computer-implemented method of Example 45 that may optionally include that the indication includes an implicit indication comprising a dynamic DL grant that schedules DL reception within the UL sub-band or a guard band.

Example 48 is the computer-implemented method of Example 45 that may optionally include that the indication includes an explicit indication comprising an information element in a DL downlink control information (DCI) message or an uplink DCI message.

Example 49 is the computer-implemented method of Example 45 that may optionally include that the indication includes an explicit indication comprising an information element in a group common downlink control information (GC-DCI) message.

Example 50 is the computer-implemented method of Example 45 that may optionally include that receiving communications from the UE based on non-SBFD operations occurs within a SBFD allocation.

Example 51 is the computer-implemented method of Example 50 that may optionally include that the indication comprises a period of time between an end of a downlink control information (DCI) message scheduling a DL grant and a start of a dynamic DL grant exceeding a threshold period of time.

Example 52 is the computer-implemented method of Example 51 that may optionally include that the duration of the non-SBFD operations within the SBFD allocation comprises a number of slots.

Example 53 is the computer-implemented method of Example 52 that may optionally include that the number of slots comprises a number of SBFD slots that span the dynamic DL grant and corresponding repetitions.

Example 54 is the computer-implemented method of Example 52 that may optionally include that the number of slots comprises a number of SBFD slots that span the dynamic DL grant, corresponding repetitions, and physical uplink control channel messages for hybrid automatic repeat request acknowledgement (HARQ-ACK).

Example 55 is the computer-implemented method of Example 52 that may optionally include that the number of slots comprises a number of SBFD slots that span from the start of the dynamic DL grant and extend for an indicated number of slots.

Example 56 is the computer-implemented method of Example 55 that may optionally include that the indicated number of slots comprises a radio resource control (RRC) indicated number of slots.

Example 57 is a base station (BS) comprising one or more processors configured to perform the computer-implemented method of any of claims 45 to 56.

Example 58 is a non-transitory machine-readable medium having executable instructions to cause one or more processing units to perform the computer-implemented method of any of claims 45 to 56.

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities.

Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present disclosure is not described with reference to any particular programming language. It will be appreciated that a variety of programming languages may be used to implement the teachings of the disclosure as described herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing discussion merely describes some exemplary embodiments of the present disclosure. One skilled in the art will readily recognize from such discussion, the accompanying drawings and the claims that various modifications can be made without departing from the spirit and scope of the disclosure.

1. A computer-implemented method, comprising:
determining a sub-band full-duplex (SBFD) slot is scheduled for a UE to simultaneously receive based on a downlink (DL) grant and transmit based on an uplink (UL) grant;
identifying the DL grant or the UL grant as a primary grant, wherein the DL grant or the UL grant not identified as the primary grant comprises a secondary grant; and
prioritizing the primary grant over the secondary grant using a cancellation timeline in response to the SBFD being scheduled for the UE to simultaneously receive based on the DL grant and transmit based on the UL grant.

2. The computer-implemented method of claim 1, further comprising:
determining the DL grant or the UL grant is a dynamic grant; and
identifying the dynamic grant as the primary grant.

3. The computer-implemented method of claim 2, further comprising:
determining the DL grant and the UL grant are dynamic grants; and
prioritizing the UL dynamic grant.

4. The computer-implemented method of claim 1, further comprising:
determining the DL grant and the UL grant are not dynamic grants; and
identifying the UL grant as the primary grant.

5. The computer-implemented method of claim 1, further comprising identifying the UL grant as the primary grant based on a predefined rule prioritizing UL grants over DL grants.

6. The computer-implemented method of claim 1, wherein the cancellation timeline is defined based on a minimum period of time between a last symbol of a downlink control information (DCI) message scheduling a UL grant and a first symbol of a DL grant.

7. The computer-implemented method of claim 6, wherein the minimum period of time between the last symbol of DCI scheduling a UL grant and the first symbol of the DL grant is determined based on UE capability.

8. The computer-implemented method of claim 6, wherein the minimum period of time between the last symbol of DCI scheduling a UL grant and the first symbol of the DL grant is predefined

9. The computer-implemented method of claim 6, wherein the cancellation timeline is defined based on a minimum sub-carrier spacing of one or more of downlink control information (DCI), DL grant, and UL grant).

10. The computer-implemented method of claim 1, further comprising identifying the DL grant as the primary grant based on a predefined rule prioritizing DL grants over UL grants.

11. The computer-implemented method of claim 1, wherein the cancellation timeline is defined based on a period of time the UE requires to process a received physical downline shared channel (PDSCH) message.

12. The computer-implemented method of claim 11, wherein the cancellation timeline is defined based on twice the period of time.

13. The computer-implemented method of claim 11, wherein the cancellation timeline is defined based on twice the period of time plus a constant.

14. A user equipment (UE) comprising one or more processors configured to perform operations comprising:
determining a sub-band full-duplex (SBFD) slot is scheduled for a UE to simultaneously receive based on a downlink (DL) grant and transmit based on an uplink (UL) grant;
identifying the DL grant or the UL grant as a primary grant, wherein the DL grant or the UL grant not identified as the primary grant comprises a secondary grant; and
prioritizing the primary grant over the secondary grant using a cancellation timeline in response to the SBFD being scheduled for the UE to simultaneously receive based on the DL grant and transmit based on the UL grant.

15. The UE of claim 14, wherein the one or more processors are further configured to perform operations comprising:
determining the DL grant or the UL grant is a dynamic grant; and
identifying the dynamic grant as the primary grant.

16. The UE of claim 15, wherein the one or more processors are further configured to perform operations comprising:
determining the DL grant and the UL grant are dynamic grants; and
prioritizing the UL dynamic grant.

17. The UE of claim 14, wherein the one or more processors are further configured to perform operations comprising:
determining the DL grant and the UL grant are not dynamic grants; and
identifying the UL grant as the primary grant.

18. A non-transitory machine-readable medium having executable instructions to cause one or more processing units to perform a method, the method comprising:
determining a sub-band full-duplex (SBFD) slot is scheduled for a UE to simultaneously receive based on a downlink (DL) grant and transmit based on an uplink (UL) grant;
identifying the DL grant or the UL grant as a primary grant, wherein the DL grant or the UL grant not identified as the primary grant comprises a secondary grant; and
prioritizing the primary grant over the secondary grant using a cancellation timeline in response to the SBFD being scheduled for the UE to simultaneously receive based on the DL grant and transmit based on the UL grant.

19. The non-transitory machine-readable medium of claim 18, the method further comprising identifying the UL grant as the primary grant based on a predefined rule prioritizing UL grants over DL grants.

20. The non-transitory machine-readable medium of claim 18, wherein the cancellation timeline is defined based on a minimum period of time between a last symbol of a downlink control information (DCI) message scheduling a UL grant and a first symbol of a DL grant.
